(19) United States
(12) Patent Application Publication
(10) Pub. No.: US 2009/0109120 A1
(43) Pub. Date: Apr. 30, 2009

(54) Low Windload Phasing Structure

(75) Inventors: Leslie E. Oliver, Thousand Oaks, CA (US); Daniel G. Gonzalez, Topanga, CA (US); Dino C. Gonzalez, Thousand Oaks, CA (US)

Correspondence Address: CROWELL & MORING LLP;INTELLECTUAL PROPERTY GROUP, P.O. BOX 14300, WASHINGTON, DC, 20044-4300, US

(73) Assignee: Malibu Research Associates, Inc., Camarillo, CA (US)

(21) Appl. No.: 11/933,074

(22) Filed: Oct. 31, 2007

(51) Int. Cl. H01Q 3/46; H01Q 3/00

(52) U.S. Cl. 343/909

(57) ABSTRACT

A microwave phasing structure configured to reflect microwaves within an operation frequency band includes a planar array of phasing. The plurality of phasing elements may be supported by a support grid having a first predefined spacing interval. The phasing structure may include a planar pattern including a plurality of openings having a second predefined spacing interval. The phasing structure may include a support means for securing the phasing array and the planar pattern substantially in parallel.

### FIELD OF THE INVENTION

The present invention relates in general to reflecting and focusing electromagnetic radiation, and more particularly to a low-windload phasing structure configured to electromagnetically emulate a desired reflective surface of selected geometry over an operating frequency band.

### BACKGROUND

In modern antenna and communication systems, reflective surfaces have been designed with specific geometries for reflecting microwaves within a operating frequency band. Similarly, substantially planar surfaces have been utilized to reflect incident electromagnetic waves within a operating frequency band.

The use of a substantially planar microwave reflector antenna configuration to emulate a curved reflective surfaces of any geometry, has been suggested. U.S. Pat. No. 4,905,014 issued to Gonzalez et al., Feb. 27, 1990, the contents of which are fully incorporated herein by reference, teaches a phasing structure emulating desired reflective surfaces regardless of the geometry of the physical surfaces to which the microwave phasing structure is made to conform, wherein the structure may be fabricated as a fraction of the wavelength of the operating frequency of the phasing surface. The aforementioned technology, marketed as Flat Parabolic Surface (FLAPS™) technology accomplishes the aforementioned function using a dipole antenna placed in front of a solid metallic ground plane. However, such phasing structures are highly undesirable for low-windload applications due to high wind resistance of the structure.

A low-windload structure has been suggested to provide another version of FLAPS technology. U.S. Pat. No. 6,198,457, issued to Walker et al., Mar. 6, 2001, teaches a low-windload phasing structure including FLAPS technology, the contents of which are fully incorporated herein by reference. However, the low-windload version as taught may incur losses in performance due to arrangement of the low-windload structure. Leakage levels of such an arrangement may be unacceptable. Further, losses in performance may be caused by weather (i.e., rain) loading the structure with water, reducing the response of the structure.

While conventional antenna structures teach phasing antennas of multiple geometries, such systems are limited by vulnerability of phasing structure response. Further such structures may not meet performance requirements.

### BRIEF SUMMARY OF THE INVENTION

Disclosed and claimed herein is a microwave phasing structure configured to reflect microwaves within an operation frequency band, the microwave phasing structure having a planar array of phasing elements supported by a support grid having a first predefined spacing interval. In one embodiment, the microwave phasing structure includes a planar pattern including a plurality of openings having a second predefined spacing interval. In another embodiment, the microwave phasing structure includes a support means for securing said phasing array and said planar pattern substantially in parallel.

Other aspects, features, and techniques of the invention will be apparent to one skilled in the relevant art in view of the following description of the exemplary embodiments of the invention.

### BRIEF DESCRIPTION OF THE DRAWINGS

FIG. 1 depicts a phasing structure according to one or more embodiments of the invention;

FIG. 2 depicts one embodiment of the support matrix for the phasing structure of FIG. 1;

FIG. 3 depicts a side view of one embodiment of the phasing structure of FIG. 1;

FIG. 4 depicts a an embodiment of the phasing structure of FIG. 1; and

FIGS. 5A-B depict embodiments of a phase pattern of the phasing structure of FIG. 1.

### DETAILED DESCRIPTION OF EXEMPLARY EMBODIMENTS

One aspect of the invention is to provide a phasing structure comprised of a planar array of phasing elements and a planar pattern, such that the phasing structure may emulate a desired reflective surface. According to another embodiment of the invention, the phasing structure may exhibit low resistance to wind, thereby facilitating the installation of the phasing structure where physical conditions (e.g., turbulent air flow) would otherwise prevent such installations, or render it highly undesirable to do so. According to another embodiment of the invention, a phasing structure may be provided to interoperate with a feed assembly for use as a reflective antenna.

According to another aspect of the invention, a phasing structure may be provided with improved leakage characteristics, such that planar pattern the phasing structure may be configured as a substantially perfect reflective screen to provide improved leakage response of incident electromagnetic energy. Similarly, the planar pattern may be configured to address effects of water and/or rain on the performance of the phasing structure such that the response of phasing elements employed by the phasing structure, including resonance, are not effected.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation. Therefore, “A, B or C” means any of the following: A; B; C; A and B; A and C; B and C; A, B and C. An exception to this definition will occur only when a combination of elements, functions, steps or acts are in some way inherently mutually exclusive.

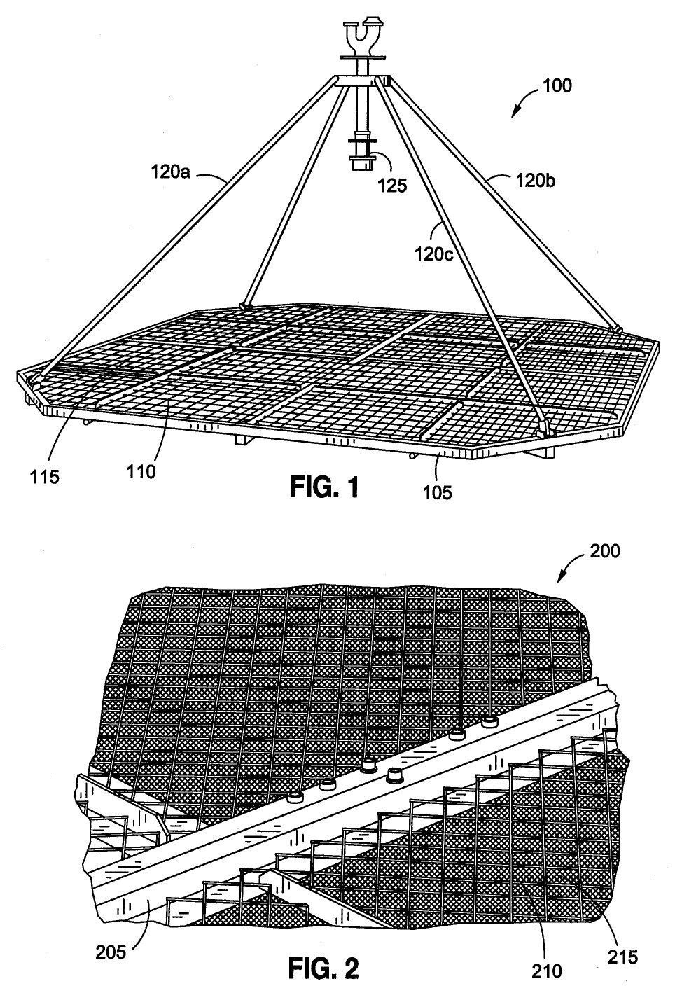

Referring now to FIG. 1, depicted is one embodiment of a phasing structure 100 configured in accordance with the principles of the invention. Namely, phasing structure 100 is configured as a planar phasing structure comprised of a support frame 105, which secures a planar array of phasing elements 110 and a planar pattern 115. In one embodiment of the invention, support frame 110 may include an outer frame assembly surrounding the planar array of phasing elements 110 and planar pattern 115. As shown, support frame 105 is depicted with a generally rectangular shape having a cut-off corner design. However, it should of course be appreciated that support frame 105 may be configured in any number of shapes and/or sizes based on, in part, the desired phasing response.

In another embodiment of the invention, the support frame 110 may include a plurality of vertical and/or horizontal support members extending to an outer periphery of the support frame 110. In another embodiment, the vertical and/or horizontal support members may provide a sub-frame of support frame 110. Further, it may be appreciated that support frame 105 does not require vertical and/or horizontal support members. The support frame 105 may be constructed of, for example, aluminum, carbon composite or fiberglass. It should of course be appreciated that any other materials capable of functioning as a support for sub-panels of the invention may be similarly used.

In another embodiment, phasing structure 100 may be mounted to a pedestal (not shown), wherein the pedestal has a base for mounting to a surface. The support frame 105 of phasing structure 100 may be mounted to the opposite end of the pedestal by means of a steering platform capable of aiming the reflector at a desired direction.

According to another embodiment, phasing structure 100 may include a plurality of support arms 120a-c securing feed assembly 125 in a fixed position. Support arms 120a-c may be coupled to support frame 105. In certain embodiments, support arms 120a-c may be configured to support an additional phasing structure (not shown). As may be appreciated, the additional phasing structure may be employed to provide a cassegrain configuration. Further, the additional phasing structure may be similarly constructed as the phasing structure 100. As may be appreciated, support arms 120a-c may be embodied as a single support arm securing feed assembly 125. In certain embodiments, support arms may be coupled to coupled to one of support frame 105 and a pedestal (not shown) providing support for support frame 105.

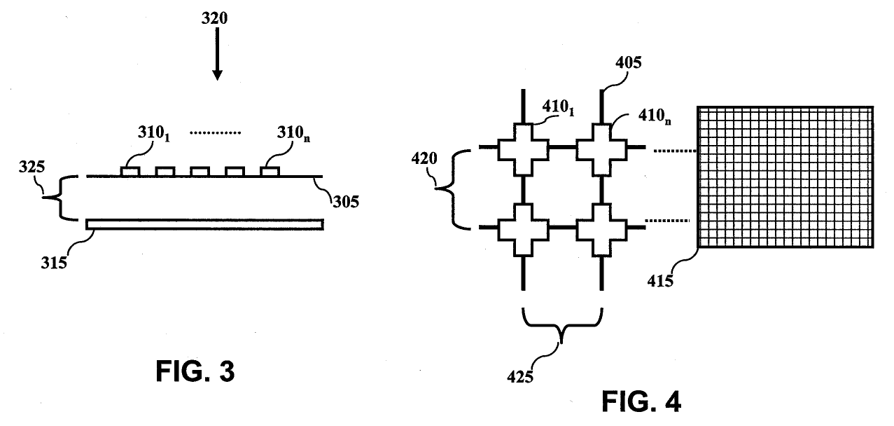

According to another aspect of the invention, phasing structure 100 may be configured to focus the incident electromagnetic waves (within the operating frequency band of the microwave phasing structure) using the planar array of phasing elements 110 and a planar pattern 115, where path lengths of the incident electromagnetic waves to the focal point of the focusing element are electronically phase equalized without requiring the use of a conventional dielectric lens for path length compensation. As such, the planar array of phasing elements 110 may be coupled to an underlying support grid coupled to support frame 105 as will be described below with reference to FIG. 3.

Incident electromagnetic waves transmitted from a source located far away may be focused to a focal point near the phasing structure 100, such that a feed assembly may detect an incident wave without the internal installation of a parabolic reflector antenna. In one embodiment, the feed assembly 115 may be arranged at a focal point of phasing structure 100. It may be appreciated the feed assembly 115 may be one of feed horn and/or feed horn array. According to another embodiment, phasing structure 100 may be configured to reflect electromagnetic energy within a frequency range employed by the phasing structure. Further, phasing structure 100 may be configured to be transmissive to electromagnetic energy outside of the operation frequency range employed by the phasing structure.

According to another aspect of the invention, phasing structure 100 may be configured to provide conversion and/or rotation polarization to incident electromagnetic waves. In certain embodiments, the planar array of phasing elements 110 may be configured to reflect energy with the same phase shift relative to each other. As such, the planar array of phasing elements 110 will have no influence on the reflected polarization and polarization of the phasing structure may be determined by feed assembly 115. However, in certain embodiments the planar array of phasing elements 110 may be configured to reradiate incident electromagnetic energy with a 90° relative phase shift and may result in converting 45° linear incident electromagnetic energy into circular polarization. In this fashion, phasing structure 100 may be configured to provide left and right circular as well as horizontal and vertical linear polarizations with a single feed assembly 115. Similarly, phasing structure 100 may be configured to convert horizontal linear to vertical linear polarization according to another embodiment. It should of course be appreciated that other types of polarization capable of converting incident electromagnetic energy on phasing structure 100 may be similarly used.

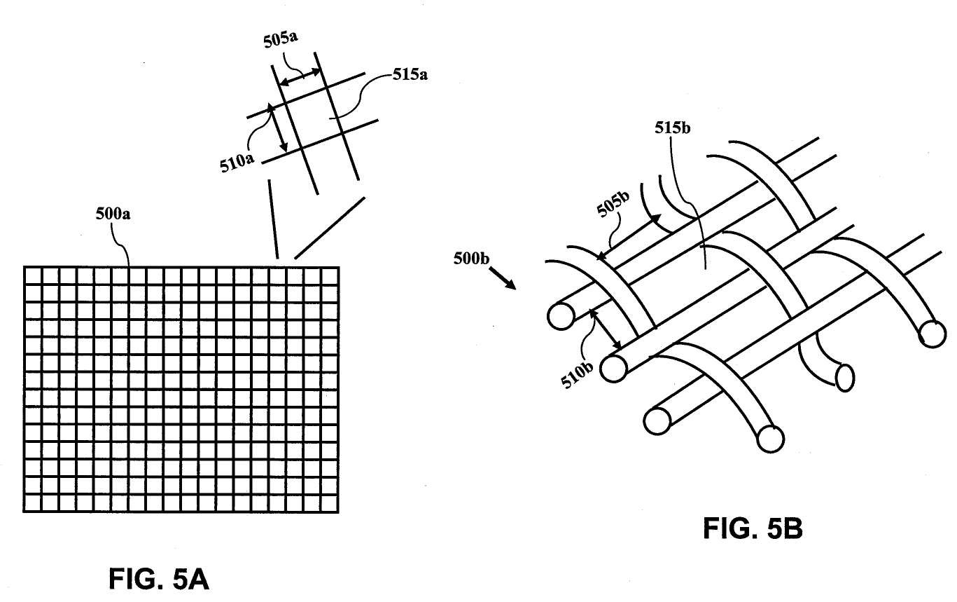

Referring now to FIG. 2, depicted is an expanded view of the phasing structure of FIG. 1. As shown, support member 205 secures a support grid 210 underlying and supporting a planar array of phasing elements (e.g., planar array of phasing elements 110) as will be described below in more detail with respect to FIG. 3. Similarly, support member 205 secures planar pattern 215 as will be described below in more detail with respect to FIG. 5. As may be appreciated, support member 205 may be one element of a support frame (e.g., support frame 105). In one embodiment, the underlying support grid holding the planar array of phasing elements 210 and/or the planar pattern 215 may be coupled to support member 205 by at least one of a bond, weld, compression and any other type of joint in general. Similarly planar pattern 215 may be bonded to a rear surface of support member 205.

According to another embodiment of the invention, the planar array of phasing elements may be mounted at intersections of support grid 210 as will further be described in more detail with reference to FIG. 4. As such, planar array of phasing elements (e.g., planar array of phasing elements 110) may include an arrangement of electromagnetically-loading structures configured to emulate a desired reflective geometry. Such electromagnetically-loading structures may vary in dimension, having an orientation and interspacing from each other. In certain embodiments, such electromagnetically-loading structures may correspond to the electromagnetically-loading structures disclosed in the previously-incorporated U.S. Pat. No. 4,905,014, the details of which are fully disclosed therein. By way of example, the arrangement of electromagnetically-loading structures may comprise an array of metallic patterns, where each metallic pattern having a cross (i.e., X) configuration with dimensions, orientation, and interspacing such that the desired reflective surface of selected geometry is obtained. Each metallic pattern may constitute a shorted crossed dipole.

Referring now to FIG. 3, a side view is depicted of elements of the phasing structure of FIG. 1. In one embodiment, planar array of phasing elements 310₁₋ₙ (e.g, planar array of phasing elements 110) are mounted to an underlying support grid 305. In one embodiment, support grid 305 may include a plurality of dielectric rods and/or wires as will be described below in more detail with reference to FIG. 4. As shown, the planar array of phasing elements 310₁₋ₙ are separated a distance 325 from planar pattern 315. As may be appreciated distance 325 may be determined based on the operation frequency of the phasing structure (e.g., phasing structure 100). In one embodiment, distance 325 may correspond to as 15% of operation frequency wavelength. According to another embodiment of the invention, planar array of phasing elements 310₁₋ₙ and planar pattern 315 may be configured to reflect incident electromagnetic waves, as indicated by 320, within a operating frequency band. In yet another embodiment, rods and/or wires of support gird 305 may be on the order of 0.015 to 0.050 inches. It should of course be appreciated that any other thickness of support grid which is capable of functioning as a support may be similarly used.

According to another aspect of the invention, a phasing structure (e.g., phasing structure 100) employing planar array of phasing elements 310₁₋ₙ and planar pattern 315 may be provided with improved leakage characteristics, such that planar pattern 315 the phasing structure may be configured as a substantially perfect reflective screen to provide improved leakage response of incident electromagnetic energy. Similarly, planar pattern 315 may be configured to address effects of water and/or rain on the performance of the phasing structure such that the response of phasing elements employed by the phasing structure, including resonance, are not effected.

Referring now to FIG. 4, a disassembled view is shown of elements of the phasing structure of FIG. 1. if shown of antenna arrangement. As shown, a planar array of phasing elements 410₁₋ₙ (e.g, planar array of phasing elements 110 or 310₁₋ₙ) may be arranged and/or mounted to an underlying support grid 405 (e.g., support grid 215 or 305). In one embodiment, planar array of phasing elements 410₁₋ₙ. may be secured to support grid 405 employing one of an expoxy bond coat and/or adhesive in general. Alternatively, phasing elements 410₁₋ₙ may be physically crimped to support grid 405. In certain embodiments, support grid 405 may comprise dielectric rods and/or wires or other suitable insulative or dielectric material, such as Kevlar™, Teflon™ and Vectran™. However, it should be appreciated that the support grid 405 may be any structure capable of supporting the planar array of phasing elements 410₁₋ₙ. According to another embodiment, support grid 405 may have spacing intervals 420 and 425 such that grid intersections are spaced up to about λ/2 wavelength apart, where λ may be a desired wavelength of energy to be received by the antenna. The planar array of phasing elements 410₁₋ₙ and planar pattern 415 (e.g, planar pattern 115 or 315) may be arranged and mounted to a support frame (e.g., support frame 105) for reflecting a desired wavelength to a focal point of a reflector. In another embodiment, the planar array of phasing elements 410₁₋ₙ may be electrically thin phasing elements configured to electromagnetically emulate of a desired reflective surface regardless of the geometry of the physical surface to which the electrically thin phasing elements are made to conform. As used hereinafter, the term “electrically thin” shall mean on the order of a fraction of the wavelength of the operating frequency of the phasing structure (e.g., phasing structure 100).

Referring now to FIGS. 5A-B, a plurality of planar pattern types may be employed in the phasing structure of FIG. 1. Referring first to FIG. 5A, planar pattern 500a is one embodiment thereof. Planar pattern 500a may be configured to act as a ground plane for phasing elements (e.g., planar array of phasing elements 210 or 310₁₋ₙ). According to another embodiment, planar pattern 500a may be configured to reflect electromagnetic energy with a frequency in the operation range of a phasing structure (e.g., phasing structure 100) to which planar pattern 500a may be employed in. Further, planar pattern 500a may be configured to be transmissive to electromagnetic energy with a frequency outside of the operation range of a phasing structure (e.g., phasing structure 100) to which planar pattern 500a may be employed in. As shown planar pattern 500a includes a plurality of vertical and horizontal members forming a grid structure. In certain embodiments, planar pattern 500a may have spacing intervals 505a and 510a between each of the vertical and horizontal members. Spacing intervals 505a and 510a may be designed based on a operation frequency of the phasing structure (e.g., phasing structure 100). As may be appreciated the spacing intervals 505a and 510a may be designed to provide a plurality of apertures 515a to enable low resistance to airflow including wind.

According to another embodiment of the invention, planar pattern 500a may be manufactured by one of a wire mesh construction. As such, planar pattern 500a may be constructed of, for example, aluminum, stainless steel or galvanized steel. It should of course be appreciated that any other materials capable of functioning as a support for sub-panels of the invention may be similarly used. In yet another embodiment, planar pattern 500a may be on the order of 0.015 to 0.050 inches. It should of course be appreciated that any other thickness of planar pattern which is capable of functioning with phasing structure 100 may be similarly used.

Referring now to FIG. 5B, planar pattern 500b is shown having a weaved configuration according to one or more embodiments of the invention. Similar to planar pattern 500a above, planar pattern 500b may be configured to act as a ground plane for phasing elements (e.g., planar array of phasing elements 210 or 310₁₋ₙ). According o one embodiment, planar pattern 500b includes a plurality of weaved vertical and horizontal rods and/or wires forming a grid structure. The woven construction may provide stability of planar pattern 500b spacing to maintain a desired electrical response. In certain embodiments, planar pattern 500b may have spacing intervals 505b and 510b between each of the vertical and horizontal members. Spacing intervals 505b and 510b may be designed based on a operation frequency of the phasing structure (e.g., phasing structure 100). As may be appreciated the spacing intervals 505b and 510b may be designed to provide a plurality of apertures 515b to enable low resistance to airflow including wind.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A microwave phasing structure configured to reflect microwaves within an operation frequency band comprising:
a planar array of phasing elements supported by a support grid having a first predefined spacing interval;
a planar pattern including a plurality of openings having a second predefined spacing interval; and
a support means for securing said planar array and said planar pattern substantially in parallel.

2. The microwave phasing structure of claim 1, wherein said first predefined spacing interval is larger than said second predefined spacing interval.

3. The microwave phasing structure of claim 1, wherein said second predefined spacing interval is at least partially characterized by a reduction in an amount of frequency leakage of the microwaves at the operating frequency band.

4. The microwave phasing structure of claim 1, wherein said plurality of phasing elements are coupled to intersections of the support grid.

5. The microwave phasing structure of claim 1, wherein said planar array of phasing elements are tuned to operate at a first frequency and the planar pattern is tuned to operate at a second frequency, wherein said first and second frequencies are within the operation frequency band.

6. The microwave structure of claim 1, the planar array phasing elements is configured to emulate a desired reflective geometry.

7. The microwave phasing structure of claim 1, wherein the planar pattern comprises a weaved pattern of regularly spaced horizontal and vertical lines forming said plurality of openings at said first predefined spacing interval.

8. The microwave phasing structure of claim 1, wherein the support means is arranges a feed assembly at a focal point of the microwave phasing structure.

9. The microwave phasing structure of claim 1, wherein the planar array of phasing elements and the planar surface are configured to exhibit low resistance to wind.

10. The microwave phasing structure of claim 1, wherein said phasing arrangement is configured to be resonant at a frequency outside of said operating frequency band.

11. A microwave phasing structure configured to reflect microwaves within an operation frequency band comprising:
a planar array of phasing elements supported by a support grid having a first predefined spacing interval;
a planar pattern including a plurality of openings having a second predefined spacing interval; and
a support frame configured to arrange said planar array and said planar pattern substantially in parallel.

12. The microwave phasing structure of claim 11, wherein said first predefined spacing interval is larger than said second predefined spacing interval.

13. The microwave phasing structure of claim 11, wherein said second predefined spacing interval is at least partially characterized by a reduction in an amount of frequency leakage of the microwaves at the operating frequency band.

14. The microwave phasing structure of claim 11, wherein said plurality of phasing elements are coupled to intersections of the support grid.

15. The microwave phasing structure of claim 11, wherein said planar array of phasing elements are tuned to operate at a first frequency and the planar pattern is tuned to operate at a second frequency, wherein said first and second frequencies are within the operation frequency band.

16. The microwave structure of claim 11, the planar array phasing elements is configured to emulate a desired reflective geometry.

17. The microwave phasing structure of claim 11, wherein the planar pattern comprises a weaved pattern of regularly spaced horizontal and vertical lines forming said plurality of openings at said first predefined spacing interval.

18. The microwave phasing structure of claim 11, wherein the support frame is further configured to arrange a feed assembly at a focal point of the microwave phasing structure.

19. The microwave phasing structure of claim 11, wherein the planar array of phasing elements and the planar surface are configured to exhibit low resistance to wind.

20. The microwave phasing structure of claim 11, wherein said phasing arrangement is configured to be resonant at a frequency outside of said operating frequency band.
